(19) United States
(12) Patent Application Publication
(10) Pub. No.: US 2016/0019371 A1
(43) Pub. Date: Jan. 21, 2016

(54) System and method for musculoskeletal pain and injury evaluation and treatment

(71) Applicant: RedPill LLC, Fort Worth, TX (US)

(72) Inventor: Willem Kramer, Fort Worth, TX (US)

(21) Appl. No.: 14/799,617

(22) Filed: Jul. 15, 2015

Related U.S. Application Data
(60) Provisional application No. 62/025,515, filed on Jul. 17, 2014.

(51) Int. Cl. G06F 19/00

(52) U.S. Cl. CPC G06F 19/3481

(57) ABSTRACT

A computer-implemented method for evaluating and treating musculoskeletal pain. The human body is sub-divided into categories of organs and communication pathways between the organs in a relational database. Descriptors are assigned to the organs and the communication pathways to differentiate between the organs and the communication pathways. An input is received from a user, wherein the input is at least one of the organs present in a pain location as indicated by a patient being treated by the user. An output is displayed, wherein the output is a name of at least one organ in connective communication with the organs present in the pain location. The output is utilized to facilitate evaluation and, optionally, treatment, by ensuring proper function of organs in connective communication with the organ near the pain location based on linkage between the organs.

### CROSS-REFERENCE TO RELATED APPLICATIONS

The instant application claims benefit of provisional application Ser. No. 62/025,515 filed Jul. 17, 2014, the contents of which are incorporated herein by reference.

### BACKGROUND

1. Field of Invention

The invention relates to the field of manual and exercise therapy. Particularly, the invention comprehends a method and computer program product for calculating an output of what should be evaluated to treat an existing patient's musculoskeletal complaint to create a positive and stimulating circumstance for recovery.

2. Description of the Related Art

Currently, manual and exercise therapists depend on experience to empirically gather information about the location of pain or injury for purposes of evaluation. Several general evaluation sequences exist, i.e. Cyriax, FMS, etc.

The purpose of existing evaluation sequences is aimed at finding out what is wrong and finding the cause of the complaint to then diagnose the problem. However, pain free and proper function of an organ promotes pain free and proper function of its connecting organs. Ensuring a pain free and proper function of all organs communicating with the pain/injury site is believed to promote recovery and pain free and proper function of the organs in the damaged area.

Because organs connect, communication between organs is inevitable. Ensuring positive communication and trying to make the communication as positive as possible promotes well-being an pain free and proper function. Accordingly, there is need for an evaluation and treatment system and method which accounts for organ inter-connectivity and thus uses structural inter-organ relationships and the consequent inter-organ communication to determine which organs to evaluate and in which order. Moreover, instead of diagnosing the complaint, it presents a solution to the complaint, as follows.

### SUMMARY

Described is a computer-implemented method, and non-transitory, computer-readable medium for suggesting which organs, via an output, to evaluate when helping a patient with musculoskeletal pain and injury in a specific area. It includes clearly structured and easy to follow instructions on how to use the computerized method and how to apply the method results (evaluation-suggestion-list). The method uses structural inter-organ connections of the human body to calculate which organs require evaluating. It lists the organs connecting with, and therefore communicating with (affecting) the organs in a pain/injury area. The method is designed based on the idea that pain free and proper function of an organ promotes pain free and proper function of its connecting organs. Ensuring a pain free and proper function of all organs which communicate with the pain/injury site is believed to promote recovery and pain free and proper function of the organs in the damaged area. Based on which organs are present in a specific pain/injury area, the computerized methodology lists all the organs that communicate with the area. By evaluating the organs on the list and ensuring their pain free and proper function, a manual/exercise therapist establishes positive inter-organ communication; promoting recovery, pain free and proper function of the affected organs in the pain/injury area.

Accordingly, the instant invention comprehends a method for evaluating and treating musculoskeletal pain with a non-transitory computer-readable medium, the method comprising: sub-dividing a human body into categories of organs and communication pathways between the organs in a relational database. Descriptors are assigned to the human organ categories, namely the organs and the communication pathways, to differentiate between the organs and the communication pathways. An input is received from a user, wherein the input is at least one of the organs present in a pain location as indicated by a patient being treated by the user, termed herein painful organ. An output is displayed, wherein the output is a name of at least one organ in connective communication with the painful organs present in the pain location, termed herein communicating organ. The output is utilized to facilitate evaluation and, optionally, treatment by ensuring proper function of organs in connective communication with the organs present in the pain location based on linkage between the organs.

For assigning descriptors, an organ descriptor is assigned to each organ and a communication descriptor is assigned to each of the communication pathways between the organs, The communication pathways comprise at least one of direct communication, action communication, or segmental communication, as defined herein. For the step of receiving the input, the user enters the organs present in the pain location either manually or from a list of the organs. The painful organs present in the pain location are entered into a first of multiple columns including a column one, column two, column three, and column four, and the output is an evaluation suggestion list comprising a display of local and long distant communicating organs communicating with the organs present in the pain location, the local and long distant communicating organs organized and displayed within the column two, the column three, and the column four relative to a rank of relationship of the local and long distant communicating organs to the organs present in the pain location. Thus, the evaluation suggestion list is referenced by the user to allow the user to sequentially evaluate the organs beginning with column four and working towards column one.

### BRIEF DESCRIPTION OF THE DRAWINGS

FIG. 1 is a flow chart of the overall database design.

FIG. 2 is a flow chart of the inter-connection of the front-end (user interface), the back-end (admin interface) and the database.

FIG. 3 is a diagrammatic illustration of the different communication pathways for the organs.

FIGS. 4 to 8 are diagrammatic illustrations of different communication pathways, the involved organs and the assigned descriptors as seen in the back-end.

FIGS. 9 to 12 are diagrammatic illustrations of different communication pathways, the involved organs, the assigned descriptors and consequently linked icons as seen in the front-end.

FIG. 13 is a flow chart representing the use of the mobile application software (App.).

FIGS. 14 to 16 are the diagrammatic illustrations of the different communication pathways between organs per column as seen in the front-end.

FIG. 17a is a flow chart of the practical application of the app/methodology results.

FIG. 17b show the icons of the App. for the same flow chart of FIG. 17a related to the practical application of the app/methodology results.

FIG. 18 is a flow chart showing in which order to use the evaluation-suggestion-lists.

FIG. 19 is a listing of the used “kenn-muscles”.

FIGS. 20-22 are example screen-shots of the front-end.

The flow charts, diagrammatic illustrations and/or sections thereof represent the method with computer logic or program flow that can be executed by a specialized device or a computer and/or implemented on computer readable media or the like (residing on a drive or device after download) tangibly embodying the program of instructions. The executions are typically performed on a computer or specialized device as part of a global communications network such as the Internet. For example, a computer typically has a web browser installed within the CPU fur allowing the viewing of information retrieved via a network on the display device. A network may also be construed as a local, ethernet connection or a global digital/broadband or wireless network or cloud computing network or the like The specialized device may include any device having circuitry or be a hand-held device, including but not limited to a tablet, smart phone, cellular phone or personal digital assistant (PDA) including but not limited to a mobile smartphone running a mobile software application (App). Accordingly, multiple modes of implementation are possible and “system” or “computer program product” or “non-transitory computer readable medium” covers these multiple modes.

### DETAILED DESCRIPTION OF THE PREFERRED EMBODIMENT

The invention now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated assembly, and such further applications of the principles of the invention illustrated herein, as would normally occur to persons skilled in the art to which the invention relates.

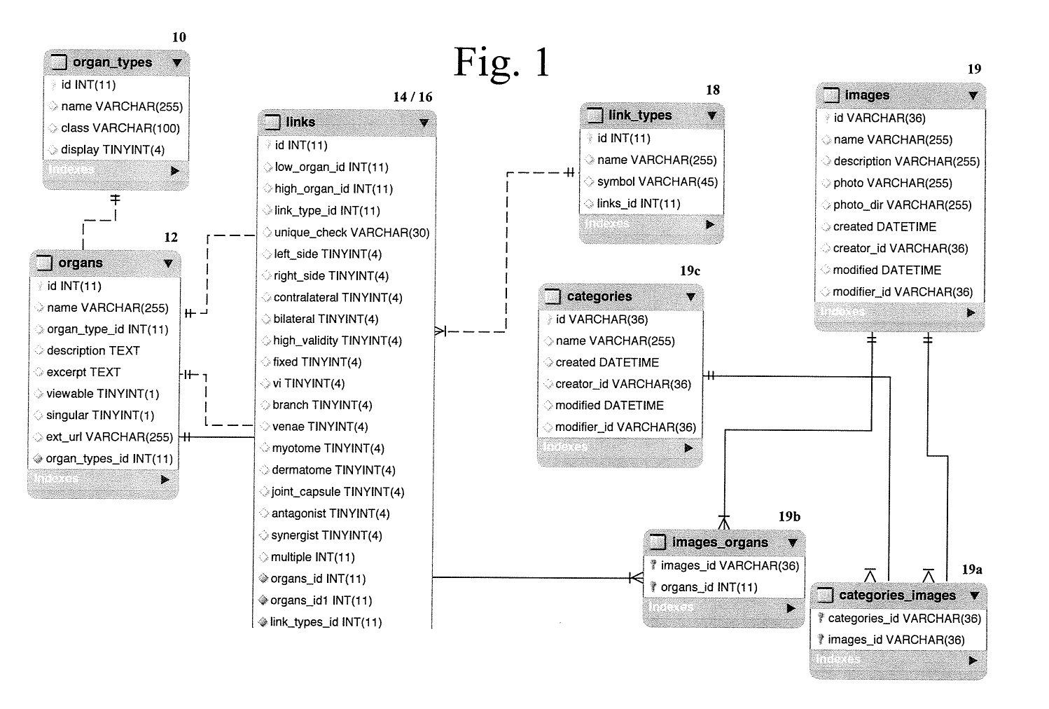

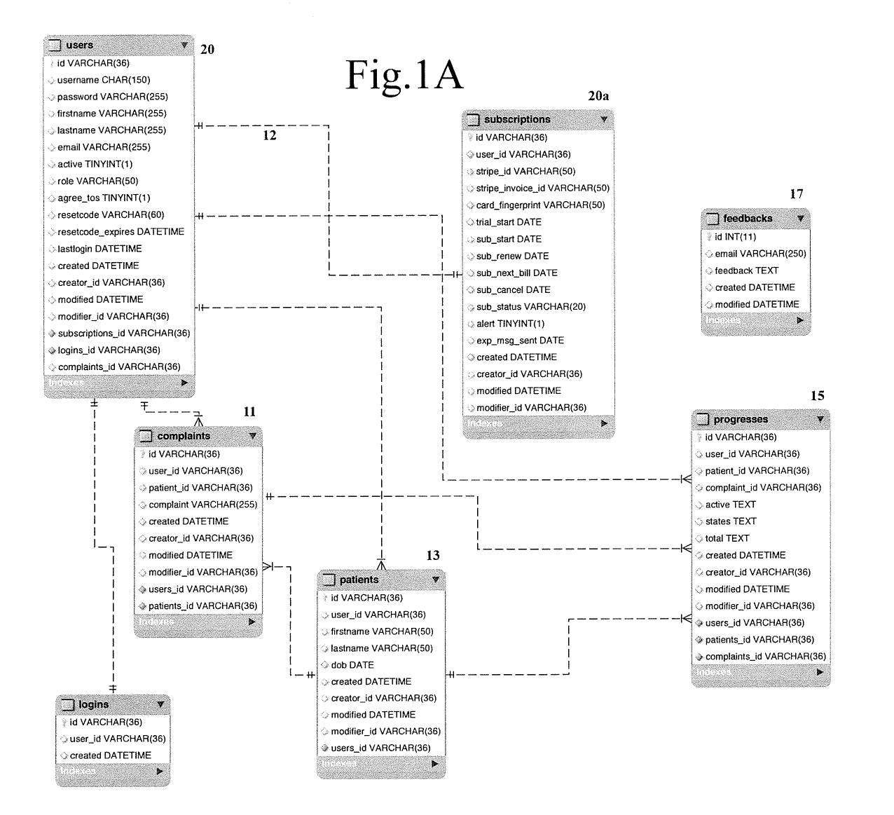

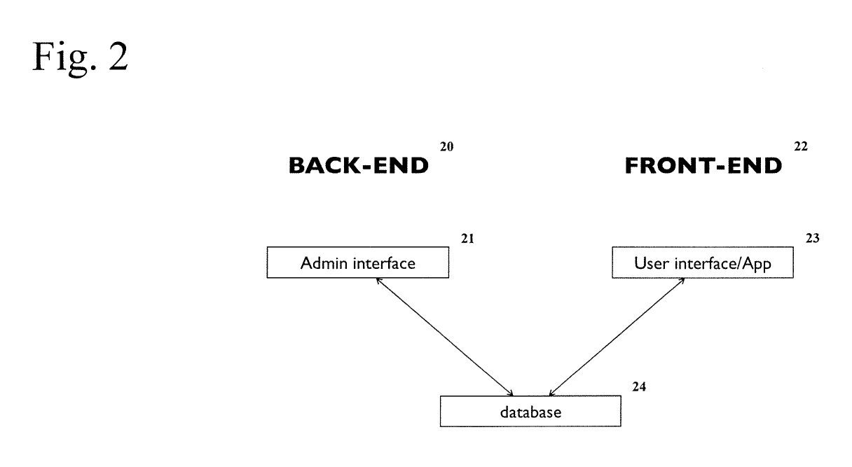

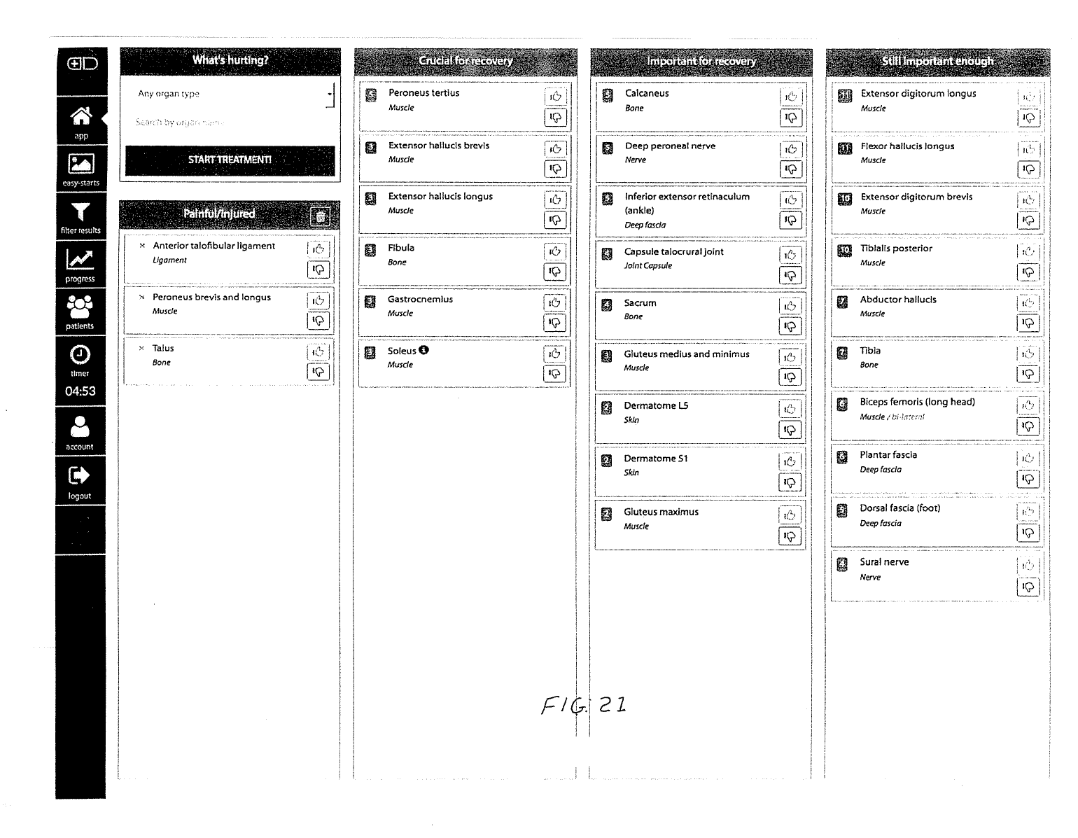

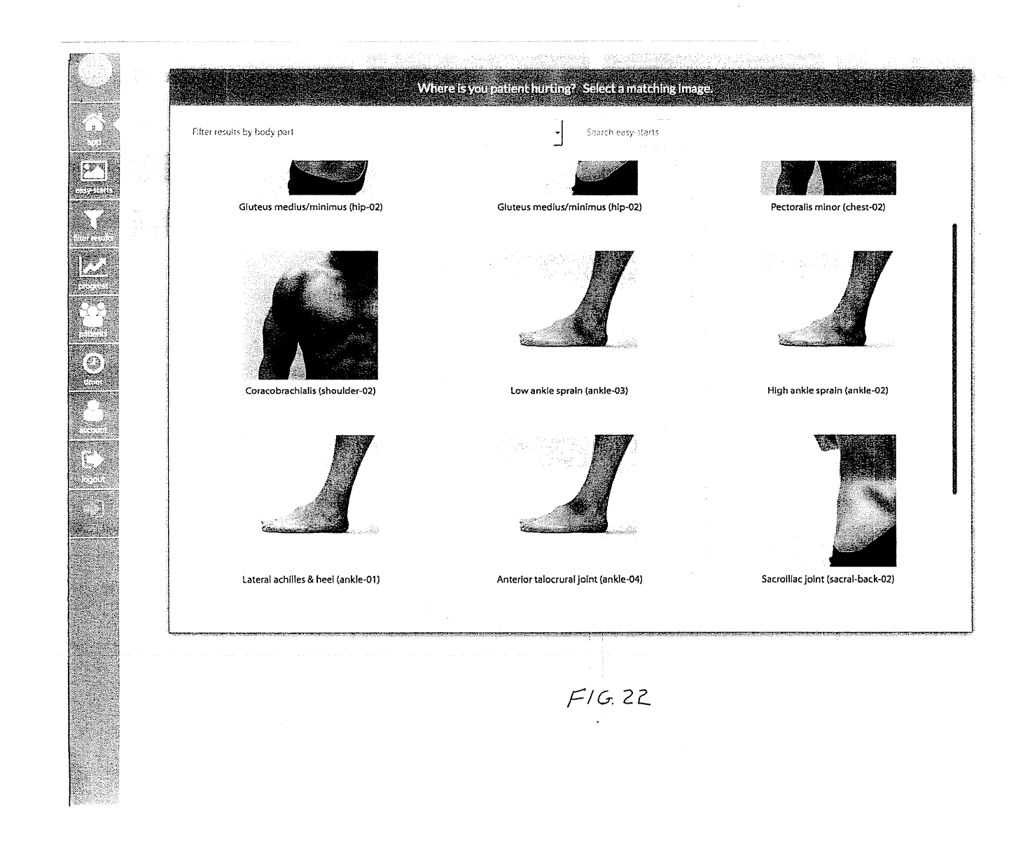

Referencing then FIGS. 1-22, shown is the database 24. As a relational database (FIGS. 1-2), the database 24 is a table-organized model including data related to a subdivision, i.e. categorization, of the human body into human organ categories 10 of organs 12 and communication pathways 14 between the organs 12. Relational database 24 shows the different tables and their relationships. For example, the “organ_types” table contains the organ-categories 10. The “organs” table contains the names of organs 12, linked to category 10, the organ-descriptors 16, the organ description (text) and image/video options 19, 19a, 19b. The “link_types” table 18 is linked to the three different communication pathways 14. The “links” table contain the communication pathway descriptors 16. The dotted lines indicate the relationships between the tables. Ultimately, as further described, relational database 24 calculates which organs 12 communicate with organs 12 selected by the user 13a (who has subscribed 20a to the system) and shows them in an ordered list.

For building the database 24, it is critical to understand the definitions behind the organs 12 of the human body and their communication pathways 14, Organs 12 as used herein means any collection of human tissues which make up a biological structure, bone, or anatomy and that perform a specific function or group of functions such as arteries, bones, deep fascia, ligament, muscle, nerves, etc. The physical connections between organs 12 make the suggested methodology possible, and understanding and implementing this knowledge concerning physical connections, and not just the organs themselves, is a critical “human step” in understanding the instant method. Because organs 12 connect, they communicate, exchange information and influence each other. In actuality, because organs 12 connect, inter-organ communication is inevitable. Only an organ 12 in isolation is free from communicating, free from being influenced, and free from exerting influence. Pain free and proper function of an organ 12 promotes pain free and proper function of its connecting organs 12 and vice versa, In other words, the database 24 and App. are built based on positive feedback 17 and positive feed-forward of inter-connecting organs 12, i.e. positive inter-organ communication.

As above, an organ 12 is a group of tissues that perform a specific function or group of functions. Whether it be a muscle, a bone, or an internal organ, per se, all tissue groups have the same measurable variables as part of the instant methodology. Measurable variable means something that can be measured or used in the calculation of the output of the instant methodology, as further described. Comprehensibly showing the connections and consequent communication between all individual body parts requires a clear and consistent subdivision of the body. Anatomists have named, defined, described and subdivided most organs. if additional subdivision is required, or if the existing subdivision is not sufficient, organs are given a unique name clearly defining a marked and identified area.

To improve their manageability, the organs 12 are sub-divided over organ-categories 10. In order to make the database 24 fully functional (to prevent data corruption/problems) some of the categories 10 contain “parts” of the other. For example, each organ-category 10 contains their embedded arterioles, capillaries and venules which are theoretically part of the “artery” and “vein” categories, and peripheral nerve endings, like end-plates and sensory endings, embedded in the organs they connect with are part of the “peripheral nerves” organ-category. Example definitions are as follows:
a. Artery: all named arteries, branches and continuations. An artery includes artery embedded arterioles, capillaries and venules. Examples; femoral artery, popliteal artery, Anterior medial malleolar artery, deep branch;
b. Bone: all named bones. A bone includes bone embedded arterioles, capillaries and venules. Examples; femur, calcaneus, Medial sesamoid bone, 1st metatarsal;
c. Brain: all named brain parts and lobes. Brain includes brain embedded arterioles, capillaries and venules. Examples; pons, frontal lobe, cerebellum, brainstem;
d. Bursa: all named bursae. A bursa includes bursa embedded arterioles, capillaries and venules. Examples; infra patellar bursa, Deep fibular collateral ligament bursa;
e. Deep fascia: all named enveloping fasciae, septa, sheets, layers and bands and area specific (described/illustrated) deep fasciae. A deep fascia organ includes deep fascia embedded arterioles, capillaries and venules. Examples; lateral intermuscular septum leg, anterior layer thoracolumbar fascia, dorsal fascia (foot), deep layer, fascia cruris over the peroneal muscles;
f. Articular disc: all named articular discs. An articular disc includes interpubic disc embedded arterioles, capillaries and venules. Example: interpubic disc;
g. Intervertebral disc: all named intervertebral discs. An intervertebral discs includes intervertebral disc embedded arterioles, capillaries and venules. Examples: intervertebral disc L3-L4, intervertebral disc Th3-Th4;
h. Joint capsule: all named joint capsules. A joint capsule includes joint capsule membranes and joint capsule embedded arterioles, capillaries and venules. Examples: capsule hip joint, capsule subtalar joint;
i. Labrum: all named labri. A labrum includes labrum embedded arterioles, capillaries and venules. Examples: acetabulofemoral labrum, glenoid labrum;
j. Lymphatic system: all named lymph nodes, vessels, trunks, etc. The lymphatic system includes lymph embedded arterioles, capillaries and venules;
k. Ligament: all named ligaments, bands and layers, A ligament includes ligament embedded arterioles, capillaries and venules. Examples: iliofemoral ligament, Posterior talofibular ligament, tibial slip;
l. Meniscus: all named menisci. Meniscus includes meniscus embedded arterioles, capillaries and venules Examples: medial meniscus, lateral meniscus;
m. Muscle: all named muscles, heads and conjoint tendons. Muscle includes tendons, tendon sheaths and aponeuroses. It also includes muscle embedded arterioles, capillaries and venules. Examples: erector spinae aponeurosis, levator scapula, rectus abdominus;
n. Nerve: all named peripheral nerves, branches and named parts of the peripheral NS. Nerve includes peripheral nerve embedded arterioles, capillaries and venules. Nerve also includes in other organs embedded motor endplates, free and encapsulated nerve endings. Examples: ischial nerve, 1st spinal nerve, deep peroneal nerve lateral branch, Examples: ischial nerve, 1st spinal nerve, Deep peroneal nerve lateral branch;
o. Skin: all named dermatomes and area specific (described, illustrated) skin. A skin organ includes skin embedded arterioles, capillaries and venules. Examples: skin over lateral aspect of the lower half of leg, skin over the anterior aspect of the shoulder joint, dermatome L4;
p. Spinal segment: all named spinal segments as a whole. A spinal segment includes spinal segment embedded arterioles, capillaries and venules. Examples: spinal segment L5, spinal segment T7;
q. Vein: all named veins as a hole. A vein includes vein embedded arterioles, capillaries and venules. Examples: great saphenous vein, Anterior femoral cutaneous veins;
r. Viscera: all thoracic and abdominal viscera. A visceral organ. eludes viscera embedded arterioles, capillaries and venules. Examples: heart, lungs, stomach, liver.

Based on which organs 12 are present in a specific pain/injury area, defined as a “painful organ” present in pain location, the computerized methodology, as output, lists all the organs 12 that communicate with the painful organ/pain location. To the right of every organ-name an “info” icon gives access to a pop-over containing illustrations, a general description (general information) and what to examine the organ 12 for, i.e. the measurable variable. By evaluating the organs 12 on the list and ensuring their proper (and pain free) function, based on this linkage (communicative and/or physical) between the organs 12, users 13a (FIG. 1) such as manual/exercise therapist establish positive inter-organ communication; promoting recovery, pain free and proper function of the affected organs 12 in the pain location or injury area in response to patient complaints 11 (FIG. 1).

Further regarding relational database 24 of FIG. 1 and additional reference to FIG. 2, the back-end 20 is the administration interface 21 and is used to enter names of organs 12, organ-categories 10, descriptors 16, references, images 19 or illustrations, videos and their unique inter-organ communication pathways 14. The back-end 20 is used by an administrator only and is used to edit the content of the database 24. FIG. 2 shows the relationship between the database 24, the back-end 20 (the admin interface) and the front-end 22. The front-end 22 is the user interface 23 of the application, as further described.

Communication, or communication pathways 14, represents the exchange of influence/information over set routes or pathways. The communication, i.e. the exchange, is two-way. If A affects B then B affects A. Inter-organ communication is possible because of structural inter-organ relationships. Note: inter-organ communication, the exchange or collaboration between organs 12, is necessary for organs 12 to sustain and function. A heart hat is not connected with the circulatory system (artery and vein) cannot function. A circulatory system without a heart is useless. A muscle that does not connect with the nervous system cannot function, and so on.

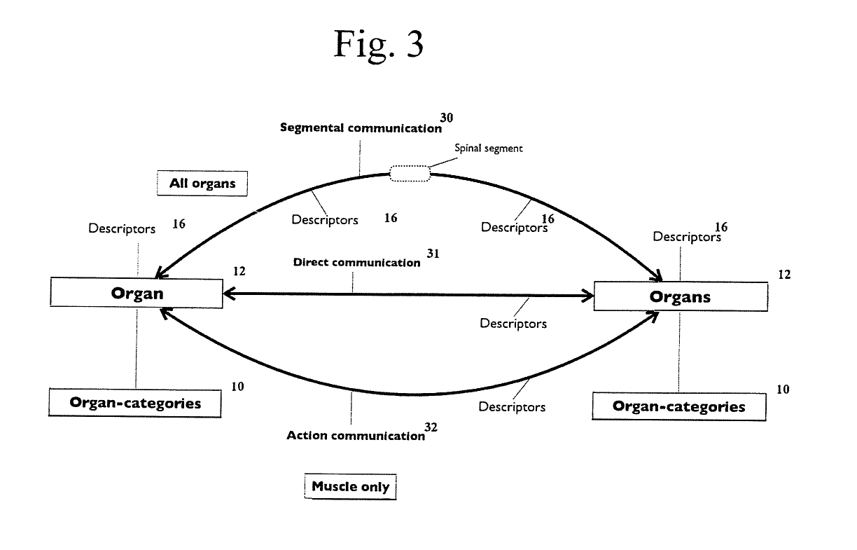

The computerized methodology uses three different kinds of communication pathways 14. With continued reference to all figures but with particular reference to FIGS. 3-12, direct communication 31 is communication between organs 12 and their neighboring/adjacent organs 12. Communication happens over “fixed” or “not fixed” pathways 14. The theory behind this is that all organs 12 in the human body have direct physical connections with their neighboring/adjacent organs. All organs 12 maintain structural inter-organ relationships with their surroundings. The connections are either designed to restrict/limit or allow a certain degree of movement between related organs. For this computerized methodology, the movement restricting inter-organ relationships are labelled “fixed” connections and those allowing some degree of movement are “not fixed” connections, hence direct communication 31. Examples include but are not limited to: “fixed”: muscle (tendon) attachments to bones, deep fasciae and ligaments. Ligamentous and fascial connections to bone. Ligamentous connections to deep fasciae and joint capsule. Nerves innervating (connecting with) muscle, bone and the spinal column. “Not fixed”: bone to bone. Skin to enveloping deep fasciae. Arteries, nerves and veins passing by surrounding organs. With the “not fixed” connections areolar or loose connective tissue is generally found between connecting organs 12. It is the connective tissue that allows (ensures) the limited amount of movement.

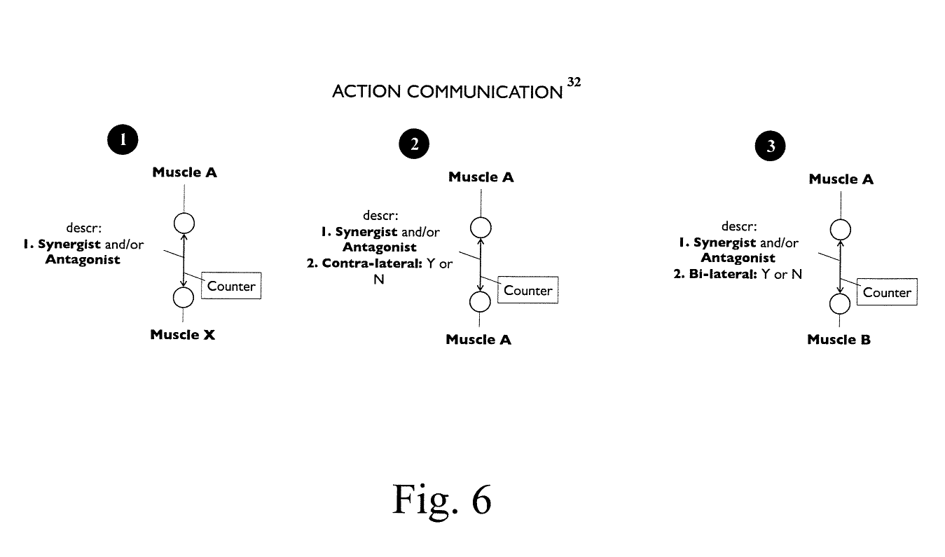

Action communication 32 is communication between muscles that generate synergistic and/or antagonistic movement(s/action(s) over the same joints) in open and/or closed chain situations. FIG. 6 in particular shows action communication 32 through a diagrammatic illustration. This type of communication is exclusive to muscles. It shows communication between muscles with the same (synergistic) and opposing (antagonistic) action over the same joints in open and closed chain situations. A muscle can have synergistic and/or antagonistic communication with its contra-lateral self (same muscle-name on opposing side) or another muscle. Shown is a “synergist/antagonist” (applied descriptor) action communication. between two different muscles. Also shown is a “synergist/antagonist”, “contra-lateral” (applied descriptor) action communication between the same muscle. The contra-lateral namesake of Muscle A can have synergistic/antagonistic communication with Muscle A. Also shown is a “synergist/antagonist” “bi-lateral” (applied descriptor) action communication between two different muscles. Muscle A can have synergistic/antagonistic communication with bi-laterally situated Muscle B. Thus, this is all taken into account as part of action communication 32 as a subset of communication pathways 14.

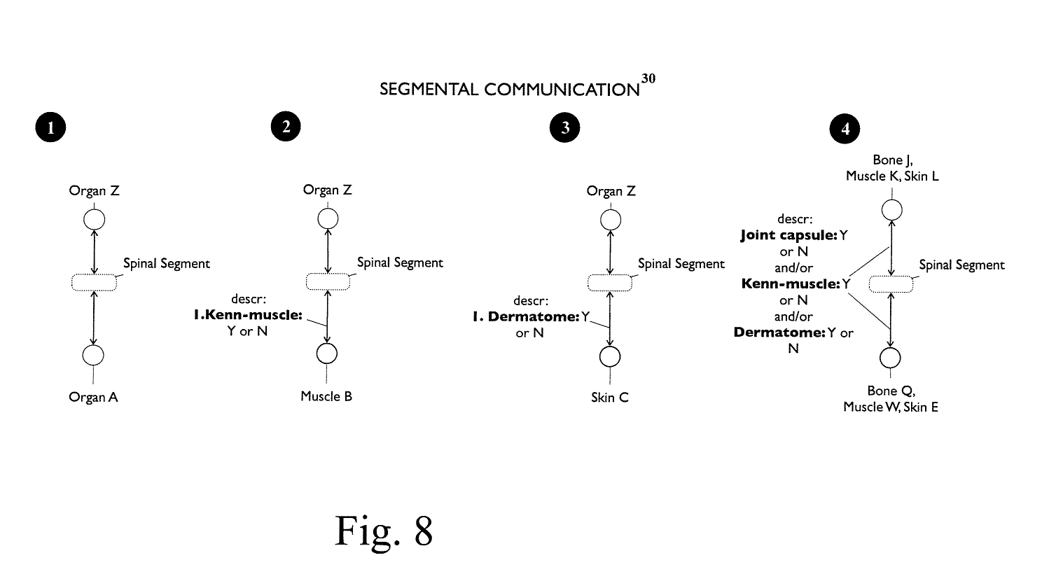

Segmental communication 30 is communication between the organs 12 that connect with the same and inter-connected spinal (cord) segments. For example, certain spinal segments (i.e. C1-C8 and L3-S2) inter-connect with spinal segments on other levels. With particular reference to FIG. 8, shown diagrammatically is segmental communication between organs. All organs that connect with the same spinal segment communicate segmentally. Spinal segments are not shown in the front-end. Shown is Organ Z communicating through Spinal segment X with Organ A. Organ Z communicates through Spinal segment X with Muscle B. The active “keen-muscle” communication descriptor makes Muscle B a kenn-muscle. Organ Z communicates through Spinal segment X with Skin. C. The active “dermatome” communication descriptor makes Skin C a dermatome. Bone, muscle and skin can communicate through Spinal segment X with bone, muscle and skin. The organs can communicate through double (“joint capsule”, “(kenn-muscle” and/or “dermatome”) pathways. Bone communication is not individually illustrated. All segmental communication is BI-LATERAL. A spinal segment communicates with a same-name-organ on the “left” and “right” side of the body. The 3rd-column only shows “kenn-muscles”, “dermatomes” and “joint capsules”. All other segmentally communicating organs are excluded from the 3rd-column.

To differentiate between organs 12 and their communication pathways 14, descriptors 16 are implemented. Thus, the descriptor 16 is a variable assigned to organs 12 and/or communication pathways 16 to differentiate between organs 12 and pathways 14. Descriptors 16 (i.e. variables) apply to certain organs 12 or communication pathways 14. An organ descriptor is assigned to a single organ 12. A communication descriptor is assigned to a. communication pathway 14, i.e. a “direct”, “action” and/or “segmental” pathway(s). The descriptors 16 apply to the pathway 14 itself and are therefore active in both dire-Lions, from “organ A” to “organ B” and “organ B” to “organ A”. Some apply to certain organ-categories 10 only, whereas some apply to all.

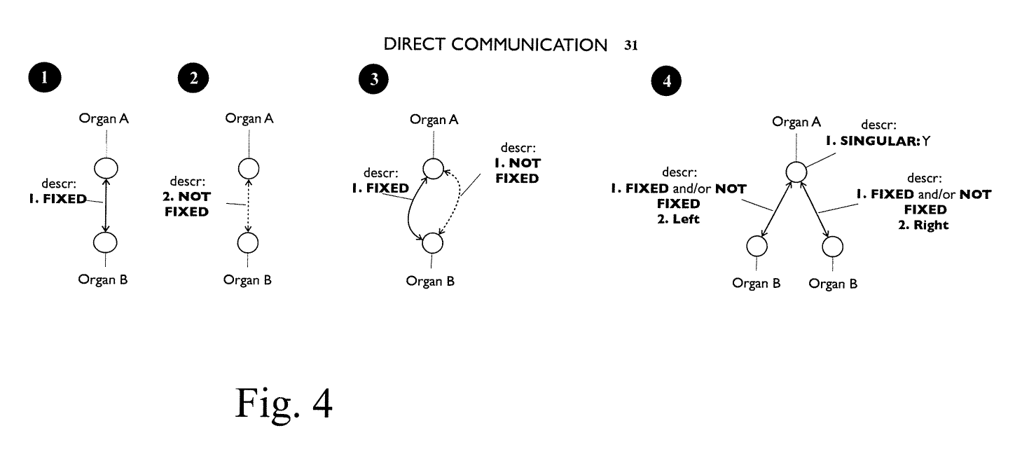

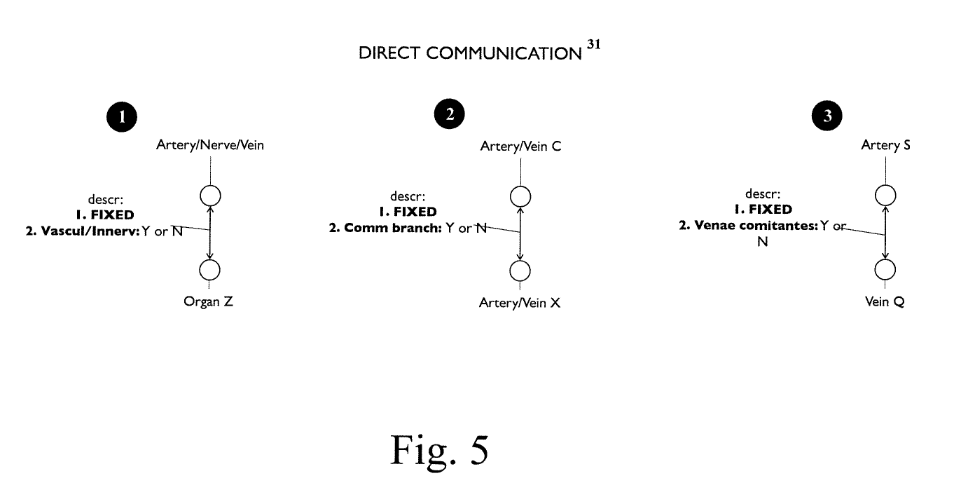

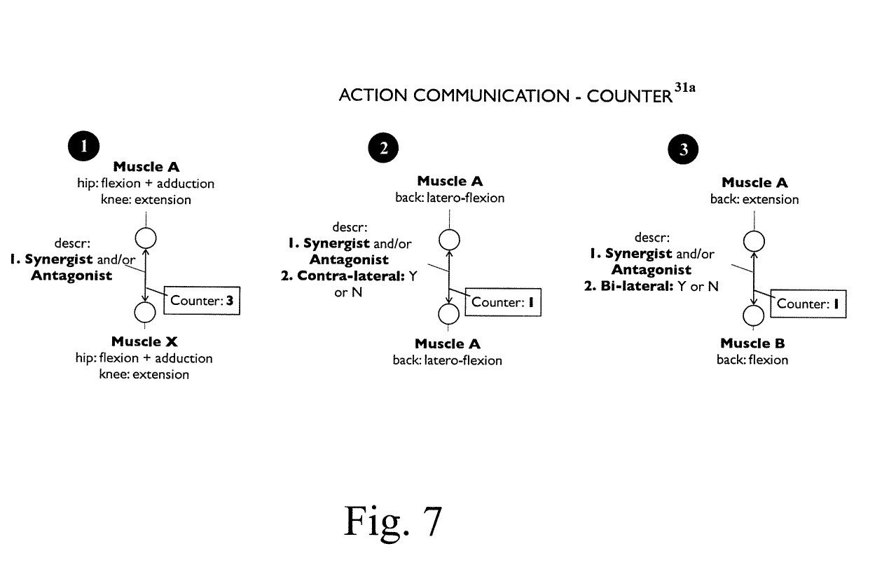

With continued reference to the figures but with particular, continued reference to FIGS. 3-12, shown are the applied descriptors 16 to the communication pathways 14, showing application and effect. For example, a singular organ 12 descriptor 16 applies to organs of ALL organ categories 10 (FIG. 3). It is a yes/no on/off variable. A communication descriptor has high/tow validity, applying to all communication pathways and to organs of ALL organ-categories, i.e. it is “high” or “low”, “fixed” or “not fixed”. Left/Right/NA applies to DIRECT communication pathways only and to organs of ALL organ-categories. Is a “Left” or “Right” or “Not Applicable” variable (FIG. 4). For example, FIG. 4 shows organ A communicating through a “fixed” (applied descriptor) pathway with organ B. Organ A communicates through a “not fixed” (applied descriptor) pathway with organ B. Organ A communicates through a “fixed” and “not fixed” (applied descriptors) pathway simultaneously with organ B. A “singular” (applied descriptor) organ communicates with the same-name organ (Organ B) twice. Communication takes place through a “left”, “fixed” and/or “not fixed” pathway AND a “fixed” and/or “not fixed” pathway. Vascularization/Innervation applies to DIRECT communication pathways only and applies only to “artery”, “peripheral nerve” and “vein” categories. It is a Yes/No, On/Off variable. (FIG. 5). FIG. 5 shows direct communication specific to artery, nerve and vein. Shown is communication between an afterylnerve/vein and another organ (Z) through a direct “fixed”, “vascularization/innervation” (applied descriptors) pathway. This specific communication indicates the vascularization for artery/vein and innervation for nerve of any and all organs. This communication runs exclusively over “fixed” connections. Shown is communication between an artery/vein (C) and the same or another artery/vein (X) through a direct “fixed”, “communicating branch” (applied descriptors) pathway. This communication runs exclusively over “fixed” connections. Generally artery connects with artery and vein connects with vein. Lymph vessels have communicating branches also. Also, shown is communication between an artery (S) and a vein (Q) through a direct “fixed”, “venae comitantes” (applied descriptors) pathway. This communication runs exclusively over “fixed” connections. The subsequent figures show similar applications and effect of descriptors 16 as shown. In summary, communicating branch: applies to DIRECT communication pathways only and applies only to “artery” and “vein” categories. It is a Yes/No. Venae comitantes applies to DIRECT communication pathways only and applies only to “vein” category, also Yes/No. Antagonist/Synergist/NA: applies to ACTION communication pathways only and applies only to “muscle” category. It is a “Synergist” or “Antagonist” (FIG. 6). Contralateral: applies to ACTION communication pathways only, and applies only to “muscle” category. It is a Yes/No On/Off variable. Bi-lateral: applies to ACTION communication pathways only and applies only to “muscle” category. It Is a Yes/No, On/Off variable. Counter: applies to ACTION communication pathways only, and applies only to “muscle” category. It is a 1, 2, 3, 4 variable (FIG. 7).

FIG. 7 shows action communication 32 and the use of the communication-pathway-counter, or action communication counter 31a. The counter 31a is used to indicate the number of synergistic and/or antagonistic communication pathways between two muscles. Muscle A flexes and adducts the hip joint and extends the knee just like Muscle X. Muscle A and

Muscle X are synergists three times. Counter: 3. Muscle A latero-flexes the back just like it's contra-lateral namesake Muscle A. Muscle A and Muscle A are synergists once. Counter: 1. Muscle A extends the back and Muscle B flexes the back. Muscle A and Muscle B are antagonists once. Counter: 1, Kenn-muscle: applies to SEGMENTAL communication pathways only and applies only to “muscle” category. It is a Yes/No, On/Off variable. (FIG. 8). Dermatome: applies to SEGMENTAL communication pathways only and applies only to “skin” category. It is a Yes/No, On/Off variable (FIG. 8). Joint capsule: applies to SEGMENTAL communication pathways only, and applies only to “bone” category. It is a Yes/No, On/Off variable (FIG. 8).

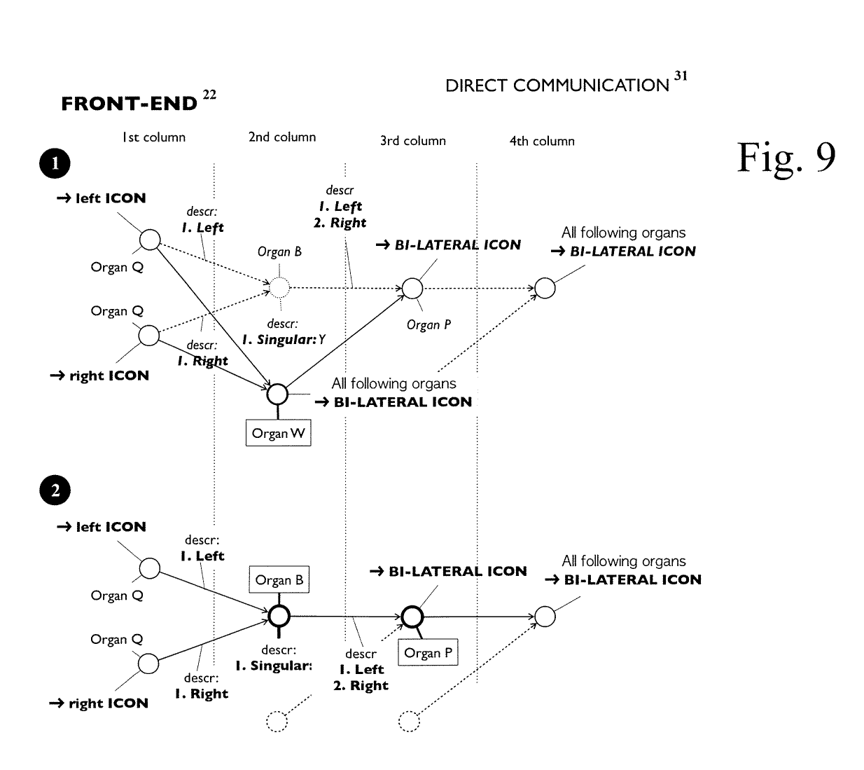

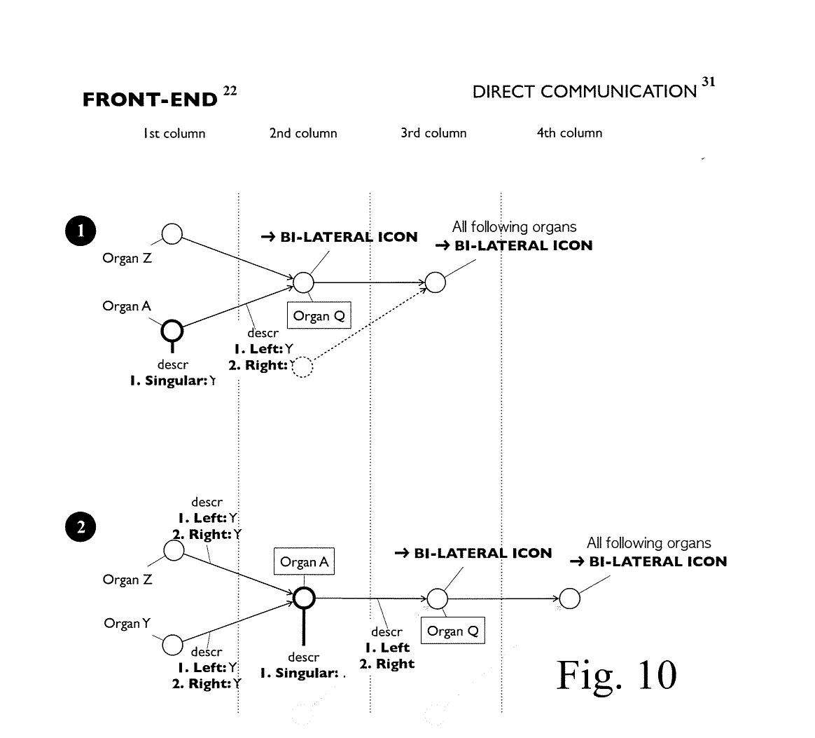

With continued reference to all figures and particularly referring back to FIGS. 9 and 10, shown is the use of the descriptors 16 in the front-end 22. The front-end 22 currently does NOT differentiate between and does not show, “fixed” or “not fixed” communications. The number of communication pathways 14 between organs 12 is expressed in the front-end 22. The higher the number, the higher the organs 12 impact on the pain/injury site.
Example 1: 1 for organ A and B
Example 2: 1 for organ A and B
Example 3: 2 for organ A and B
Example 4: 2 for organ A and B

Currently, none of the above mentioned back-end descriptors have an effect on the front-end content. The number of communication pathways 14 between organs 12 is expressed in the front-end 22. The higher the number, the higher the organs 12 impact on the pain/injury site.
Example 1: 1 for Artery/Nerve/Vein and Organ Z
Example 2: 1 for Artery/Vein C and Artery/Vein X
Example 3: 1 for Artery S and Vein Q

FIG. 9 shows direct communication 31, the use of “descriptors” and their impact on the results on the front-end 22. Shown is that 2nd-column organ communicates with 1st-column. Same-name organs are displayed with a “bi-lateral” ICON, then all following organs communicating with Organ W are shown with a “bi-lateral” ICON also. For the next example, shown is a 2nd-column organ with an active “singular” descriptor (organ B) communicating through a “left” and “right” pathway with two same-name 1st-column organs (left and right organs Q) is displayed without an ICON, the 3rd-column organ (organ P) communicating through a “left”/“right” pathway with the 2nd-column organ that has an active “singular” descriptor (organ B) is displayed with a “bi-lateral” ICON. All following organs communicating with Organ Y are displayed with a “bi-lateral” ICON also.

FIG. 10 shows another direct communication 31 example, the use of “descriptors” and their impact on the results on the front-end 22. First grouping shows a 2nd-column organ communicating through a “left”/“right” pathway with a 1st-column organ that has an active “singular” descriptor (organ A) displayed with a “bi-lateral” ICON. All following organs communicating with Organ are shown with a “bi-lateral” ICON also. The second grouping shows a 2nd-column organ with an active “singular” descriptor (organ A) communicating through “left”/“right” pathways with 2 different 1st-column organs (organ Z and organ Y) is displayed without an ICON. The 3rd-column organ (organ Q) communicates through a “left”/“right” pathway with the 2nd-column organ that has an active “singular” descriptor (organ A) is displayed with a “bi-lateral” ICON. All following organs communicating with organ Q are shown with a “bi-lateral” ICON also.

Icon as used herein means one of four icons used to differentiate between organs, displayed based on the relationship of the organ. Each is applied in response to a unique combination of organs, organ-categories, communication pathways and/or descriptors and the order in which they occur. FIG. 9 through 12 show which icon displays based on the combination of organs, organ-categories, descriptors, communication pathways and their order, e.g. Bi-lateral: the organ in question requires evaluating bi-laterally; Contra-lateral: in reference to the same-name organ mentioned in a previous column, evaluate the organ on the opposite side of the body; Left: the organ in question is present on the left side of the body; Right: the organ in question is present on the right side of the body.

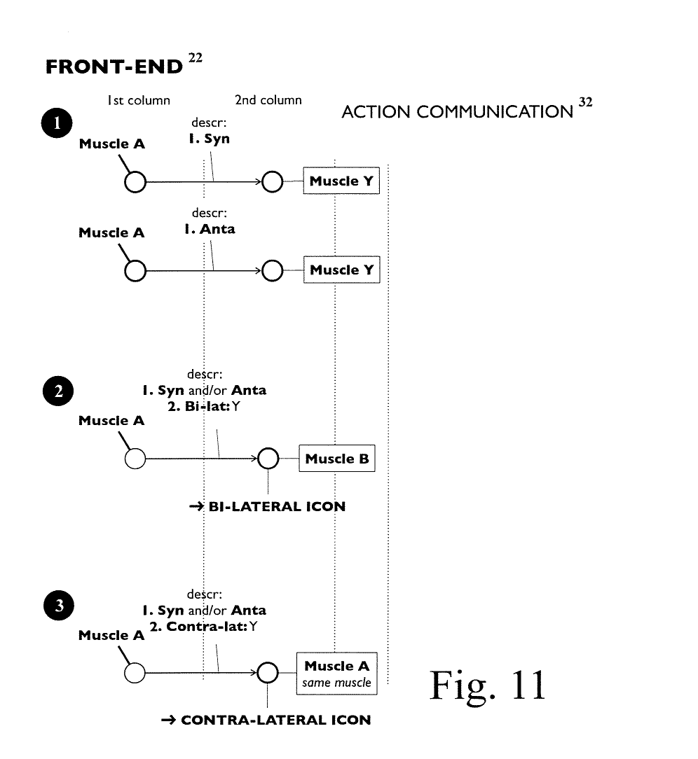

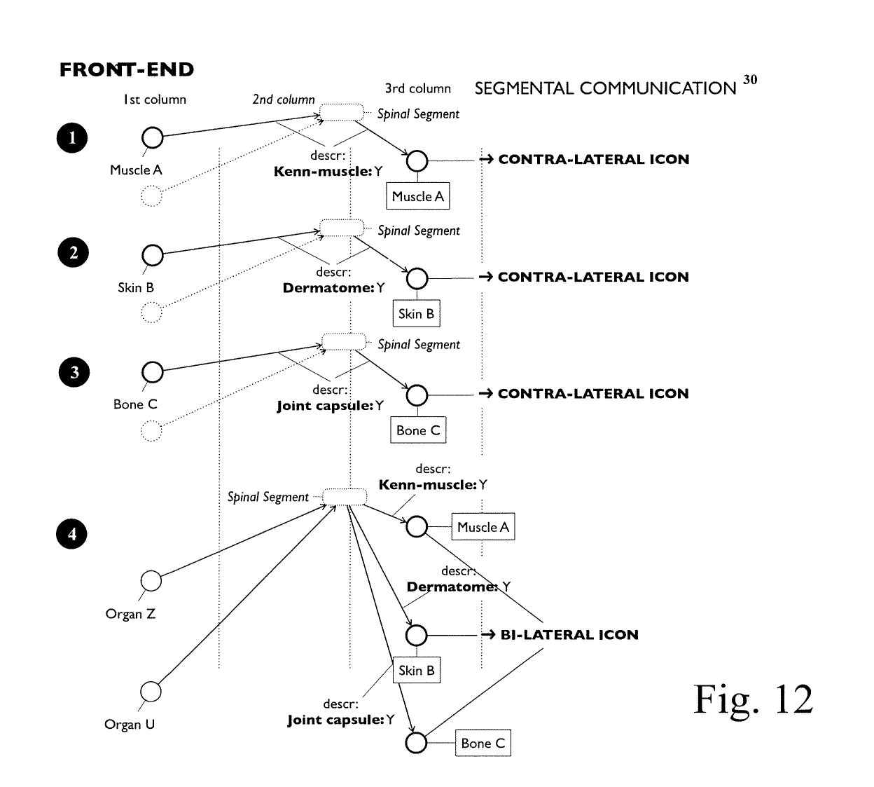

The following rules apply to “direct” communication only:
1. Left-icons and right-icons are used if an organ communicating through a “left”/“right” pathway is added twice to the 1st-column (FIG. 9 Illustration 1 and 2).
2. A bi-lateral-icon is always used if an organ communicates with an organ that is listed twice in the 1st-column (FIG. 9 Illustration 1).
3. A bi-lateral-icon is used if an organ communicates through a “left”/“right” pathway with a “singular” organ (FIG. 9 Illustration 2, FIG. 10 Illustrations 1 and 2).
4. A bi-lateral-icon is used if an organ communicates with an organ which in turn communicates through a “left”/“right” pathway with a “singular” organ 9 Illustration 1 and 2, FIG. 10 Illustrations 1 and 2).
5. In other words: a bi-lateral-icon is used if an organ communicates with an organ shown with a “bi-lateral” icon.
6. Note: “singular” organs are never shown with a “bi-lateral” icon.
   The following rules apply to “action” communication only:
1. A bi-lateral-icon is used if a muscle communicates with another muscle through a “bi-lateral” pathway (FIG. 11 illustration 2).
2. A contra-lateral-icon is used if a muscle communicates through a “contra-lateral” pathway with itself or another muscle (FIG. 11 Illustration 3).
   The following rules apply to “segmental” communication only:
1. If a muscle communicating through (a spinal segment and) a double “kenn-muscle” pathway is added to the 1st-column is listed again in the 3rd-column with a contra-lateral-icon (FIG. 12 Illustration 1).
2. If skin communicating through (a spinal segment and) a double “dermatome” pathway is added to the 1st-column it is listed again in the 3rd-column with a contra-lateral-icon (FIG. 12 Illustration 2).
3. If a bone communicating through (a spinal segment and) a double “joint capsule” pathway is added to the 1st-column it is listed again in the 3rd-column with a contra-lateral-icon (FIG. 12 Illustration 3).
4. Bone, muscle and skin communicating with a 1st-column-organ through a single “kenn-muscle”, “dermatome” and/or “joint capsule” pathway are listed in the 3rd-column with a bi-lateral-icon (FIG. 12 illustration 4).
   Note: rules for a bi-lateral-icon to appear always take precedence over rules for a contra-lateral-icon to appear. If both apply only a bi-lateral-icon shows.

With a few exceptions organs (organ-names) do not show more than once, are not repeated, in a single or over multiple columns.

### Exceptions

1. Direct communication: users can add organs communicating through an active “left” and “right” pathway twice to the 1st-column. If this happens a left-icon shows with one and a right-icon shows with the other entry.
2. Action communication: muscle communicating through a “contra-lateral” pathway with itself and added to the 1st-column repeats in 2nd-column flanked by contra-lateral ICON (FIG. 11 Illustration 3).

Segmental communication: muscle communicating through a “kenn-muscle” pathway, skin communicating through a “dermatome” pathway and bone communicating through a “joint capsule” pathway that are added to 1st-column also show in 2nd-column flanked by contra-lateral ICON (FIG. 12 illustration 1, 2 and 3).

FIG. 11 shows action communication 32, the use of “descriptors” and their impact on the front-end results. First grouping shows a muscle (muscle A) communicating through a “synergistic” AND a “antagonistic” pathway, two pathways, with one other muscle (muscle Y). No ICONS used. Second grouping shows a muscle (muscle A) communicating through a “synergistic” and/or “antagonistic” and “bi-lateral” pathway with one other muscle (muscle X). Muscle X is shown with a “bi-lateral” ICON. Third grouping shows a muscle (muscle A) communicating through a “synergistic” and/or “antagonistic” and “contra-lateral” pathway with the same-name muscle (muscle A). Muscle A is shown with a “contra-lateral” ICON.

FIG. 12 shows segmental communication 30, the use of descriptors and their impact on the front-end results. First grouping shows a 2nd-column muscle communicating through a “kenn-muscle” pathway with a 1st-column same-name muscle shows with a “contra-lateral” ICON. Second grouping shows a 2nd-column skin communicating through a “dermatome” pathway with 1st-column same-name skin shows with a “contra-lateral” ICON. Next is a 2nd-column bone communicating through a “joint capsule” (descr) pathway with 1st-column same-name bone shows with a “contra-lateral” ICON. Next shows that 2nd-column muscle, skin and bone communicating through “joint capsule”, “kenn-muscle”, “dermatome” communicating pathways with two 1st-column organs show with a “bi-lateral” ICON. Note: the “spinal segment” is no visible in the front-end 22. It is implemented in the illustration for clarification.

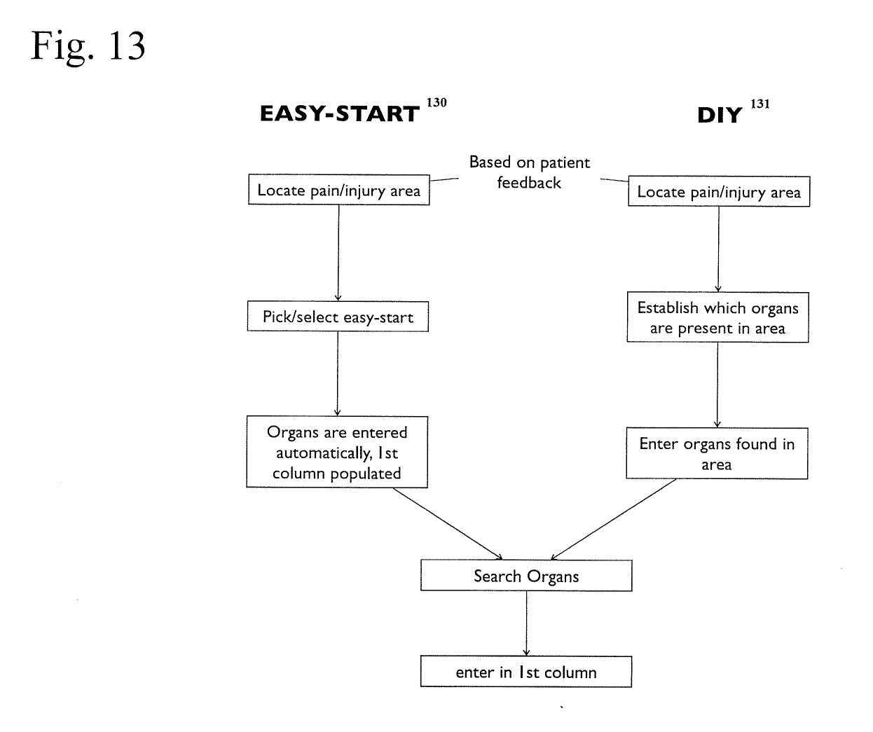

In use then, with continued reference to figures but with particular reference to FIGS. 13-20, shown is an example of the method being implemented by a mobile application software, i.e. the computer program product is an App. The app is designed to be practical. With its users 13a (FIG. 1a) (manual and exercise therapists, i.e. DOC's, PT's, chiropractors, massage therapist) in mind it is built to be responsive and to be used on computers, tablets and smartphones. The app can be used in two ways—with an easy-start 130 and do-it-yourself, or DIY 131. For easy-start 130, user enters one of the provided lists of organs (easy-start-list). The lists are based off common, often occurring, pain/injury complaints. The chosen easy-start should fit the organs/area pointed out by the patient. Therefore the easy-starts 130 are automated. By selecting an image that shows/represents pain in a certain in location, the user can populate, or add “painful” organs to, the 1st column of the app. Users can browse easy-starts 130 by category (i.e. hip, thigh, arm, ankle, lumbar back) and search by name. In the back-end (the admin) an image is linked to the organs that are supposed to populate the 1st column when the image is selected by a user. Most organs are linked with multiple images, as most organs are involved in more than one injury or pain complaint. For DIY 131, the user himself determines which painful organs are present in patients' pain/injury area and enters organs in a 1st-column, i.e. “manually”. Use of an anatomy atlas or other reference is advised. The entered organs should be the same as the organs pointed out by the patient. With both uses the patient 13 (FIG. 1) points out the organs that are hurt or hurting. He or she simply points to where it hurts, i.e. “painful”. So for the step of receiving an input from a user, the input comes from an easy-start 130 or manually DIY 131 input, and the input is at least one any painful organs present in a pain location as indicated by a patient being treated by a user. This input is entered into a first of multiple columns, i.e. a column 1 of columns 1-4.

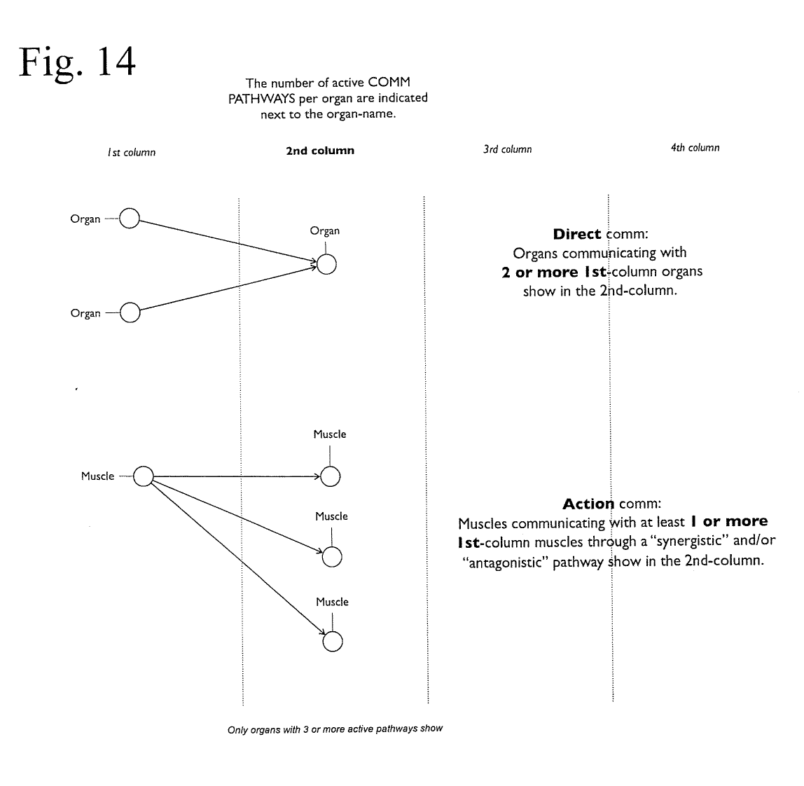

The 2nd-column shows “communicating” organs communicating through “direct” and “action” communication pathways only. FIG. 14 shows which inter-organ communication pathways are utilized by organs found in the 2nd-column.

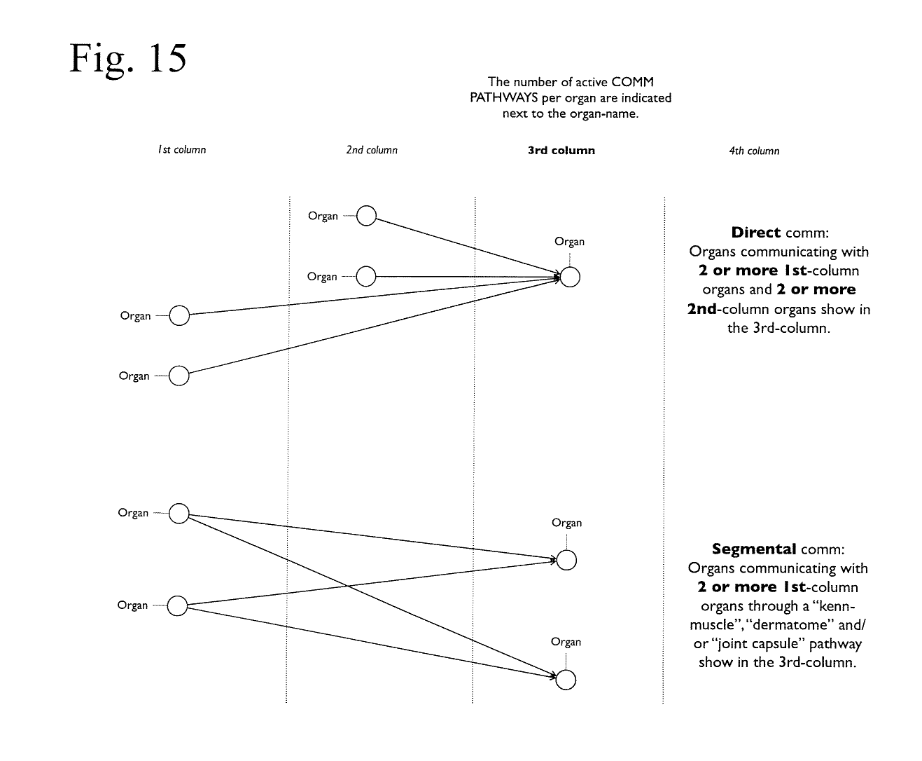

The 3rd-column shows “communicating” organs communicating through “direct” and “segmental” communication pathways only. FIG. 15 shows which inter-organ communication pathways are utilized by organs found in the 3rd-column.

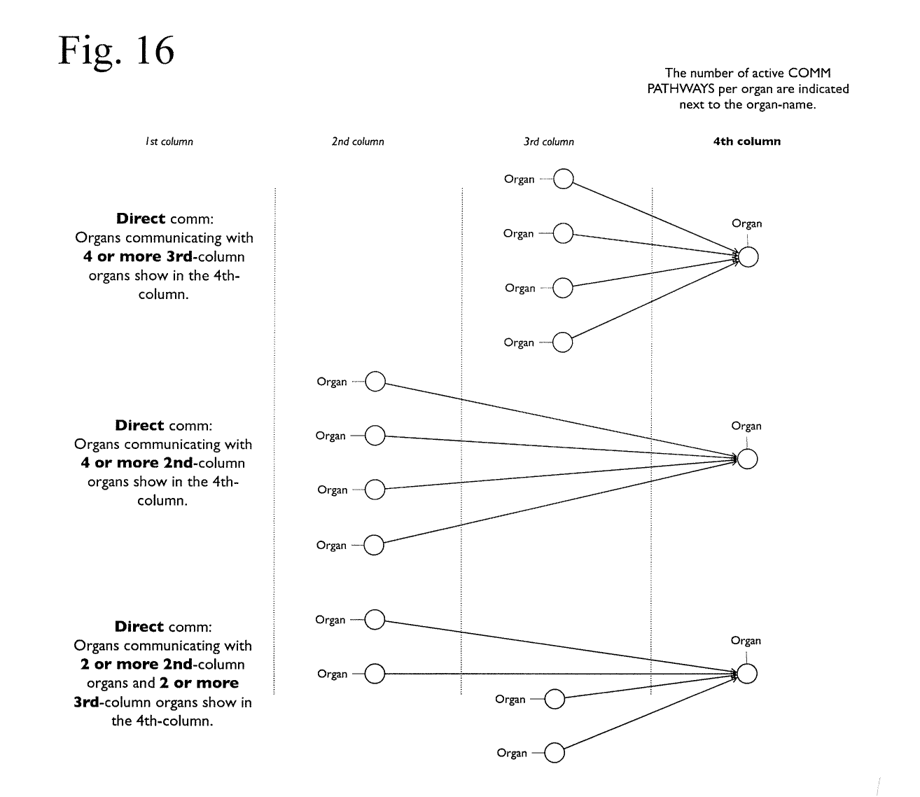

The 4th-column shows organs communicating through “direct” communication pathways only. FIG. 16 shows which inter-organ communication pathways are utilized by organs found in the 4th-column.

With the exception of the is -column, the organs are ranked. High impact organs are listed at the top. “High impact” refers to having a large number of open/active communication pathways with the organs in the 1st column. Organs of lesser impact are found at the bottom. Organs with the same number of active pathways are listed alphabetically. The 2nd, 3rd and 4th-columns show communicating organs by the following rules (see FIGS. 14, 15 and 16).

### COLUMN 1

Organ(s) entered by user.

### COLUMN 2

1. Organs relating through “direct comm” to 2 or more 1 st-column organs.
2. Muscles relating through “action comm” to 1 or more 1st-column muscles. Whole column: only organs with 3 or more active pathways show.

### COLUMN 3

1. Organs relating through “direct comm” to 2 or more 1st-column-organs and 2 or more 2nd-column-organs.
2. “Kenn-muscle”, “dermatome” and “joint capsule” relating through “segmental comm” to 2 or more 1st-column organs.

### COLUMN 4

1. Organs relating through “direct comm” to 4 or more 2nd-column organs.
2. Organs relating through “direct comm” to 4 or more 3rd-column organs.
3. Organs relating through “direct comm” to 2 or more 2nd-column-organs and 2 or more 3rd column-organs.

For all columns: the number of relationships are shown in the count. This is regardless of the kind of relationship (dir/act/seg) or the type of organs.

By entering one or more organs present in a pain/injury area the app provides an evaluation-suggestion-list as output. The list is based on local and long distance inter-organ communication of the entered organ(s). As above, the application, the computerized method, consists of four vertical columns. The 1st-column contains an organ-category “filter” (filtering the search-box) and an organ “search-box”. The other three columns are empty when the 1st-column is empty, In the 1st-column each entry, every entered organ, has a delete button. A “delete all” button makes it possible to empty the 1st-column at once. A general “filter” makes it possible to filter the 2nd, 3rd and 4th-column results based on organ-category.

Each organ is shown in name and accompanied by the name of its respective category and the number of active communication pathways. Four different icons (“left”, “right”, “contra-lateral” and “bi-lateral”) are used to indicate organ variables. Per organ text, images and video can be shown.

When a user adds one or more organs to the 1st-column the application shows their local and long distance communicating organs in columns 2, 3 and 4; it shows the evaluation-suggestion-list. Generally communication between two organs takes place over more than one pathway. The application shows how many pathways are used. A higher number, more pathways, equals more influence or more impact on the pain/injury involved organs.

Therefore, the evaluation-suggestion-list is a form of displayed output, wherein the output is a name of at least one communicating organ in connective communication with the painful organs present in the pain location, and this output is utilized to facilitate evaluation and, optionally, treatment by ensuring proper function of organs in connective communication with the organ near the pain location based on linkage between the organs, as follows.

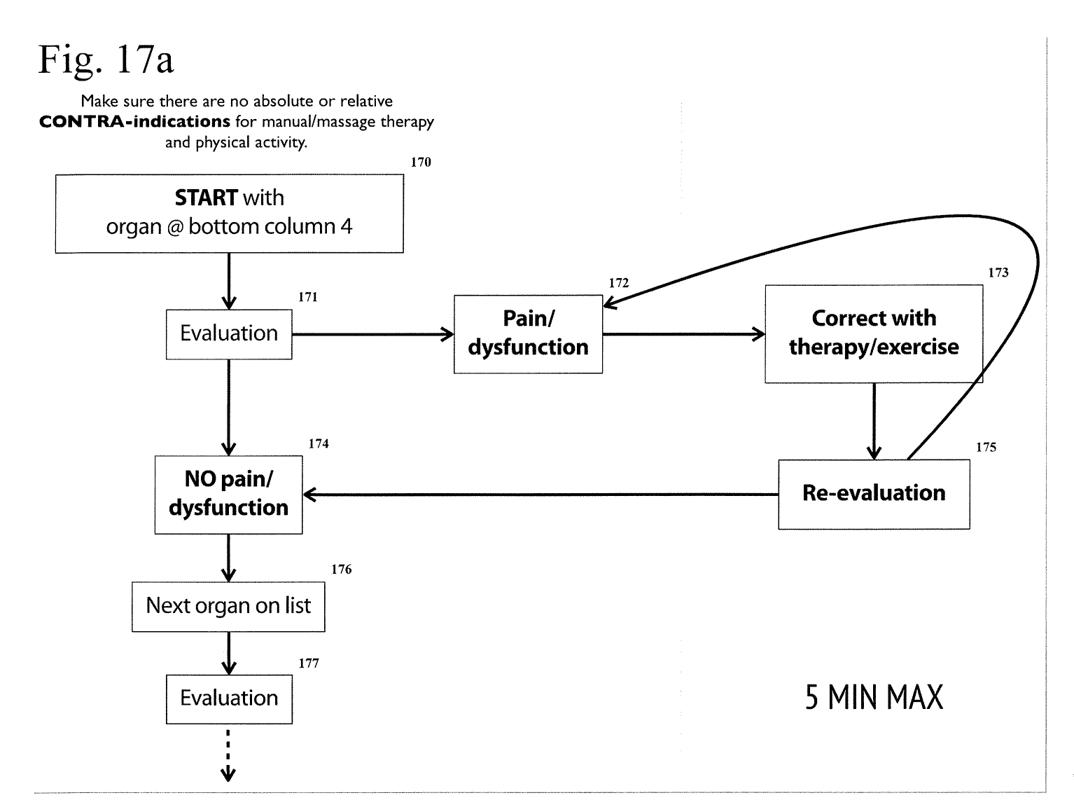

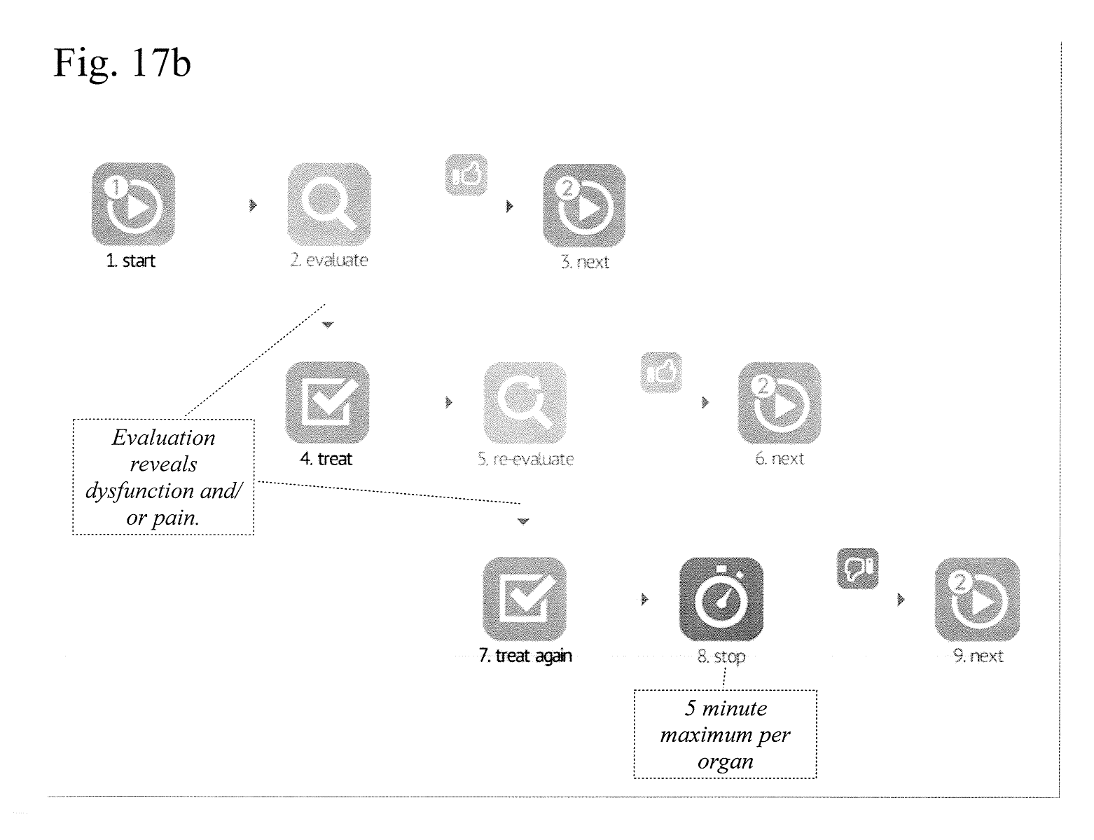

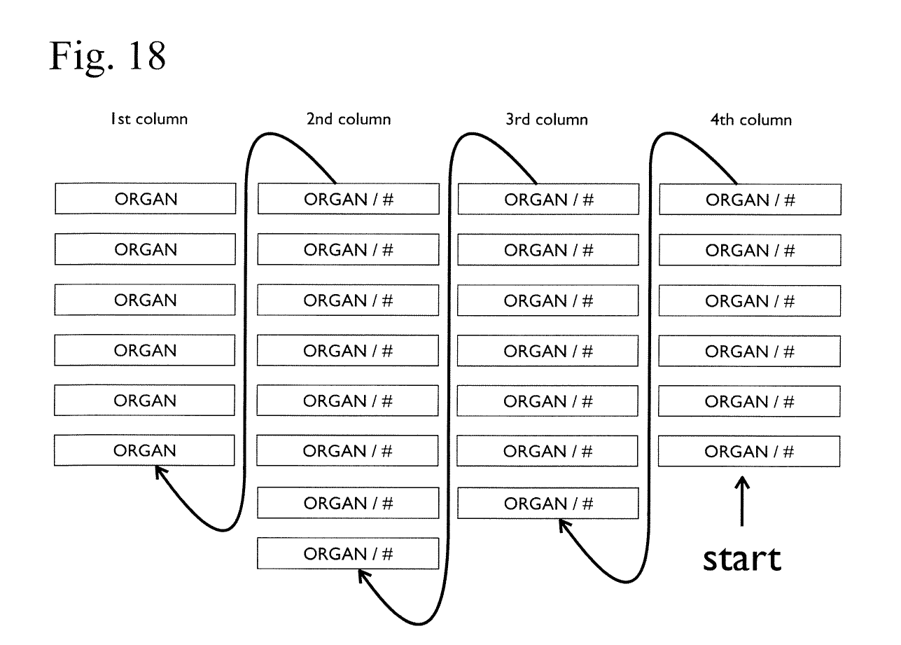

FIGS. 17-18 relate to the practical application of evaluation and treatment using the evaluation-suggestion-list as output. Before starting, the therapist, or user, makes sure there are no abs lute or relative contra-indications for manual/massage therapy and physical activity. The therapist starts each session at the bottom of column four (4) 170 and works toward the 1st organ in column one (1). Per column, the therapist works from the bottom to the top. The therapists evaluates 171 the first suggestion (1st organ) for pain and dysfunction 172. If the exam is negative, if NO pain/dysfunction is found 174, the therapist moves onto next organ list item 176. If the exam is positive, if pain/dysfunction are present 172, the therapist corrects what needs to be corrected 173, e.g. if weak, strengthen, if short, lengthen, if stuck, mobilize, etc. The therapist re-evaluates 175 regularly to measure the effect of the applied therapy. It may be advisable that a therapist t eats/exercises no longer than five minutes per organ, and this time limit can be implemented into the program. A timer starts counting down from 5 minutes and resets when a user selects the “start treatment” button and a thumbs up/down button. After 1 minutes, at 1 minute left, and he last 3 seconds the timer beeps, informing the therapist on time left. Upon reaching the time limit the therapist moves onto the next organ/list item 176 for continued evaluation 177.

Depending on the category an organ belongs to, the following therapy-adjustable-properties may require evaluation: a. pliability and tonicity; b. mobility; c. length; d. range-of-motion; e. output; f. alignment; g. pain.

FIG. 18 shows the order in which the therapist uses the evaluation-suggestion-list above.

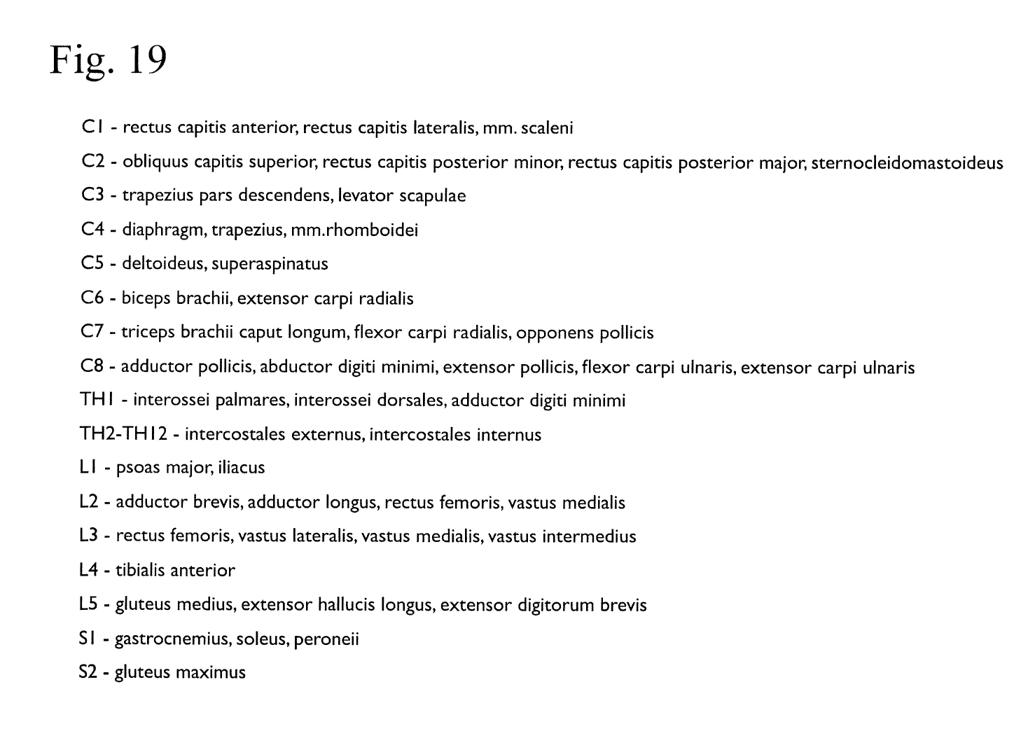

FIG. 19 shows a list of “kenn-muscles”.

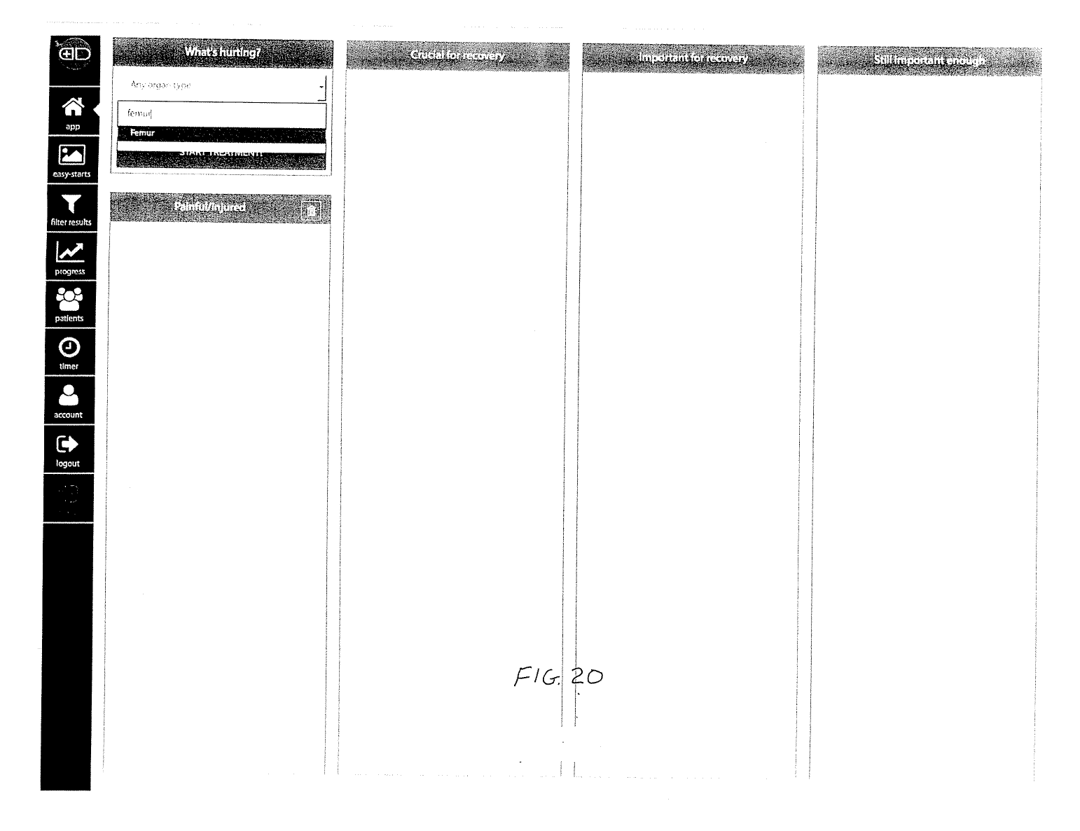

FIGS. 20-22 show screen-shots of front-end/user interface including the search field with search-field-organ-filter positioned above it, organs added to 1st-column, number of utilized, short and long-distance communication pathways between “gluteus minimus” and the first column organs, and result filter, which allows the user to filter results to one or more organ-categories. A user can register and record/save the progress 15 (FIG. 1) made during a therapeutic/treatment session. Progress is saved by selecting thumbs up buttons (indicating a functional and pain free organ) or thumbs down buttons (indicating a dysfunctional and/or painful organ) per evaluated organ and saving/storing then under a patient-complaint combination. The patient information necessary for saving the progress are first name, last name, date of birth and the complaint anterior knee pain, low back pain, etc.)). Additionally, bars and graphs in various colors visualize the progress, e.g. blue, “overall progress” (% of listed organs evaluated), green, “functional and pain free” (% of evaluated organs that are functional and pain free), red, “dysfunctional and/or painful” (% of evaluated organs that are dysfunctional and/or painful). Progress bars are used to display/show improvements made during a single therapy session. Graphs show improvements over multiple sessions and dates indicate when the treatment session took place.

I claim:

1. A method for evaluating and treating musculoskeletal pain with a non-transitory computer-readable medium, the method comprising:
subdividing a human body into categories of organs and communication pathways between said organs in a relational database,
assigning descriptors to said organs and said communication pathways to differentiate between said categories;
receiving an input from a user, wherein said input is at least one of said organs being a painful organ present in a pain location as indicated by a patient being treated by said user;
displaying an output, wherein said output is a name of at least one communicating organ in connective communication with said painful organ present in said pain location;
utilizing the output to facilitate evaluation and, optionally, treatment by ensuring proper function of said at least one communicating organ in connective communication with said painful organ present in said pain location based on linkage between said communicating organ and said painful organ.

2. The method of claim 1, wherein for the step of assigning descriptors, an organ descriptor is assigned to each said organ and a communication descriptor is assigned to each of said communication pathways between said organs.

3. The method of claim 1, wherein said communication pathways comprise at least one of direct communication, action communication, or segmental communication.

4. The method of claim 3, wherein said direct communication includes communication between said organs and neighboring or adjacent organs.

5. The method of claim 3, wherein said action communication includes communication between muscles that generate synergistic or antagonistic action over the same joint.

6. The method of claim 3, wherein said segmental communication includes communication between spinal organs that connect with spinal segments.

7. The method of claim 1, wherein for the step of receiving said input, said user enters said painful organ present in said pain location either manually or from a list of said organs.

8. The method of claim 7, wherein said painful organ present in said pain location is entered into a first of multiple columns including a column one, column two, column three, and column four.

9. The method of claim 8, wherein for the step of displaying said output, said output is an evaluation suggestion list comprising a display of a local said communicating organ and a long distant said communicating organ communicating with said painful organ present in said pain location, said local communicating organ and said long distant communicating organs organized and displayed within said column two, said column three, and said column four relative to a rank of relationship of said local communicating organ and said tong distant communicating organs to said painful organ present in said pain location.

10. The method of claim 9, further comprising the step of displaying icons based on said relationship.

11. The method of claim 10, wherein said icons are one of four icons used to differentiate between said communicating organs selected from the group consisting of bi-lateral, contra-lateral, left, and right.

12. The method of claim 9, wherein for the step of utilizing said output, said evaluation suggestion list is referenced by said user to allow said user to sequentially evaluate said painful organs and said communicating organs beginning with said column four and working towards said column one.

13. A computer program product comprising a non-transitory computer-readable medium having control logic stored therein for causing a computer to aid in evaluating and treating musculoskeletal pain, the control logic comprising computer-readable program code for causing the computer to:
subdivide a human body into categories of organs and communication pathways between said organs in a relational database;
assign descriptors to said organs and said communication pathways to differentiate between said categories;
receive an Input from a user, wherein said input is at least one of said organs being a painful organ present in a pain location as indicated b a patient being treated by said user;
display an output, wherein said output is a name of at least one communicating organ in connective communication with said painful organ present in said pain location;
utilize the output to facilitate evaluation and, optionally, treatment by ensuring proper function of said communicating organ in connective communication with said painful organ present in said pain location based on linkage between said communicating organ and said painful organ.

14. The computer program product of claim 13, wherein for assigning descriptors, an organ descriptor is assigned to each said organ and a communication descriptor is assigned to each of said communication pathways between said organs.

15. The computer program product of claim 13, wherein said communication pathways comprise at least one of direct communication, action communication, or segmental communication.

16. The computer program product of claim 13 wherein for receiving said input, said user enters said painful organ present in said pain location either manually or from a list of said organs.

17. The computer program prod of claim 16 wherein said painful organ present in said pain location are entered into a first of multiple columns including a column one, column two, column three, and column four.

18. The computer program product of claim 17, wherein for displaying said output, said output is an evaluation suggestion list comprising a display of a local said communicating organ and a long distant communicating organ communicating with said painful organ present in said pain location, said local communicating organs and said long distant communicating organs organized and displayed within said column two, said column three, and said column four relative to a rank of relationship of said local communicating organs and said long distant communicating organs to said painful organs present in said pain location.

19. The computer program product of claim 18 further comprising displaying icons based on said relationship.

20. The computer program product of claim 18 wherein for utilizing said output, said evaluation suggestion list is referenced by said user to allow said user to sequentially evaluate said painful organs and said communicating organs beginning with said column four and working towards said column one.

21. The computer program product of claim 19, wherein said icons are one of four icons used to differentiate between said communicating organs selected from the group consisting of bi-lateral, contra-lateral, left, and right.
